(19) United States
(12) Patent Application Publication
(10) Pub. No.: US 2026/0184151 A1
(43) Pub. Date: Jul. 2, 2026

(54) VEHICLE WINDOW ASSEMBLY WITH A SEALED GAP

(71) Applicant: Ford Global Technologies, LLC, Dearborn, MI (US)

(72) Inventors: Genaro Garduño Ramirez, Mexico City (MX); Abdellah Bedrouni, Farmington, MI (US); Artem Poliakov, Farmington Hills, MI (US); Claude A. McLean, Detroit, MI (US)

(21) Appl. No.: 19/008,319

(22) Filed: Jan. 2, 2025

(51) Int. Cl. B60J 10/40; B60J 10/20; B60J 10/70; B62D 25/06

(52) U.S. Cl. CPC B60J 10/40; B60J 10/20; B60J 10/70; B62D 25/06

(57) ABSTRACT

A vehicle window assembly includes a first window, and a second window adjacent to the first window. A first seal is attached to the first window. The first seal has a hook. A second seal is attached to the second window. The second seal has at least one flange. The hook of first seal and the at least one flange of the second seal interface with each other to seal a gap between the first window and the second window.

### TECHNICAL FIELD

This disclosure relates generally to sealing a gap between windows of a vehicle.

### BACKGROUND

Vehicles can include various windows. Some vehicles include window assemblies made up of more than one individual window. A moonroof, for example, can be a window assembly made up of more than one individual window. Interfacing areas between windows of a window assembly are often sealed.

### SUMMARY

In some aspects, the techniques described herein relate to a vehicle window assembly, including: a first window; a second window adjacent to the first window; a first seal attached to the first window, the first seal having a hook; and a second seal attached to the second window, the second seal having at least one flange; the hook of first seal and the at least one flange of the second seal interfacing with each other to seal a gap between the first window and the second window.

In some aspects, the techniques described herein relate to a vehicle window assembly, wherein the first window and the second window are roof windows of a vehicle.

In some aspects, the techniques described herein relate to a vehicle window assembly, wherein the first window is a forward window, and the second window is a rear window.

In some aspects, the techniques described herein relate to a vehicle window assembly, wherein the first window is a rear window, and the second window is a forward window.

In some aspects, the techniques described herein relate to a vehicle window assembly, wherein the gap extends longitudinally in a cross-vehicle direction.

In some aspects, the techniques described herein relate to a vehicle window assembly, wherein the first seal is attached to a rear edge portion of the first window, and the second seal is attached to a forward edge portion of the second window.

In some aspects, the techniques described herein relate to a vehicle window assembly, wherein the hook is a downturned hook.

In some aspects, the techniques described herein relate to a vehicle window assembly, wherein the at least one flange includes an upper flange and a lower flange.

In some aspects, the techniques described herein relate to a vehicle window assembly, wherein the upper flange is shorter than the lower flange.

In some aspects, the techniques described herein relate to a vehicle window assembly, wherein the at least one flange is configured to seal against an topside of the hook when the first window is installed prior to the second window, and configured to seal against an underside of the hook when the first window is installed after the second window.

In some aspects, the techniques described herein relate to a vehicle window assembly, wherein the at least one flange includes an upper flange and a lower flange.

In some aspects, the techniques described herein relate to a vehicle window assembly, wherein the upper flange is shorter than the lower flange.

In some aspects, the techniques described herein relate to a vehicle window assembly, wherein, when the first window is installed prior to the second window, the upper flange is configured to press the lower flange against the topside of the hook and when the gap is below a threshold distance.

In some aspects, the techniques described herein relate to a vehicle window assembly, wherein, when the first window is installed prior to the second window, the underside of the hook is configured to seal against the upper flange when the gap is below a threshold distance and configured to seal against the lower flange when the gap is at or above the threshold distance.

In some aspects, the techniques described herein relate to a vehicle window installation method, including: attaching a first seal to a first window, the first seal having a hook; attaching a second seal to a second window, the second seal having at least one flange; and installing the first window and the second window in a vehicle such that the first window and the second window are adjacent to each other and a gap between the first window and the second window is sealed by contact between the first seal and the second seal, when the first window is installed in the vehicle before the second window, a topside of the hook contacts the at least one flange to seal the gap, when the first window is installed in the vehicle after the second window, an underside of the hook contacts the at least one flange to seal the gap.

In some aspects, the techniques described herein relate to a vehicle window installation method, wherein the first window is a front roof window, and the second window is a rear roof window.

In some aspects, the techniques described herein relate to a vehicle window installation method, wherein the at least one flange includes an upper flange and a lower flange, wherein, when the first window is installed in the vehicle before the second window, the upper flange is configured to contact the lower flange to press the lower flange against the topside of the hook when the gap is below a threshold distance.

In some aspects, the techniques described herein relate to a vehicle window installation method, wherein the at least one flange includes an upper flange and a lower flange, wherein, when the first window is installed in the vehicle after the second window, the underside of the hook contacts the upper flange to seal the gap when the gap is below a threshold distance and contacts the lower flange to seal the gap when the gap is at or above the threshold distance.

In some aspects, the techniques described herein relate to a vehicle window installation method, wherein the upper flange is shorter than the lower flange.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a roof of a vehicle having a window assembly with a first window and a second window.

FIG. 2 illustrates the vehicle of FIG. 1 during installation sequence with the first window installed and the second window yet to be installed.

FIG. 2A is a close-up view of an area in FIG. 2.

FIG. 3 illustrates the vehicle of FIG. 1 during another installation sequence of the window assembly with the second window installed and the first window about to be installed.

FIG. 3A is a close-up view of an area of FIG. 3.

FIG. 4 is a section view at line 4-4 in FIG. 1.

FIGS. 5A-5C illustrates a section view through a seal assembly within the window assembly of FIG. 1 when the first window was installed prior to the second window with different distances between the first window and the second window after installation.

FIGS. 6A-6C illustrate section views through the window assembly of FIG. 1 when the second window was installed to the vehicle prior to the first window with different distances between the first window and the second window after installation.

### DETAILED DESCRIPTION

This relates generally to a window assembly having a plurality of individual windows that interface with each other. The interface between the windows of the window assembly is sealed with a seal assembly.

The sequence in which the windows are installed can change. For example, if a first window is ordinarily installed before a second window but the first window requires rework, the second window can be installed to the vehicle without the first window. The first window can then be reworked and installed to the vehicle at a later time. In exemplary embodiments, the seal assembly can provide a sealed interface for the window assembly when the first window is installed in the vehicle prior to the second window, and when the second window is installed in the vehicle prior to the first window.

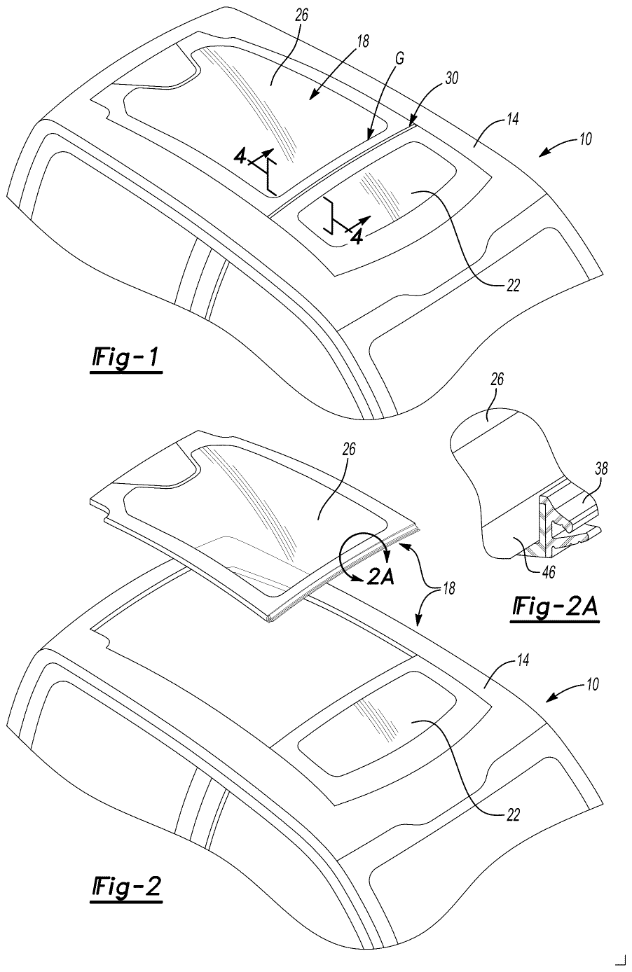

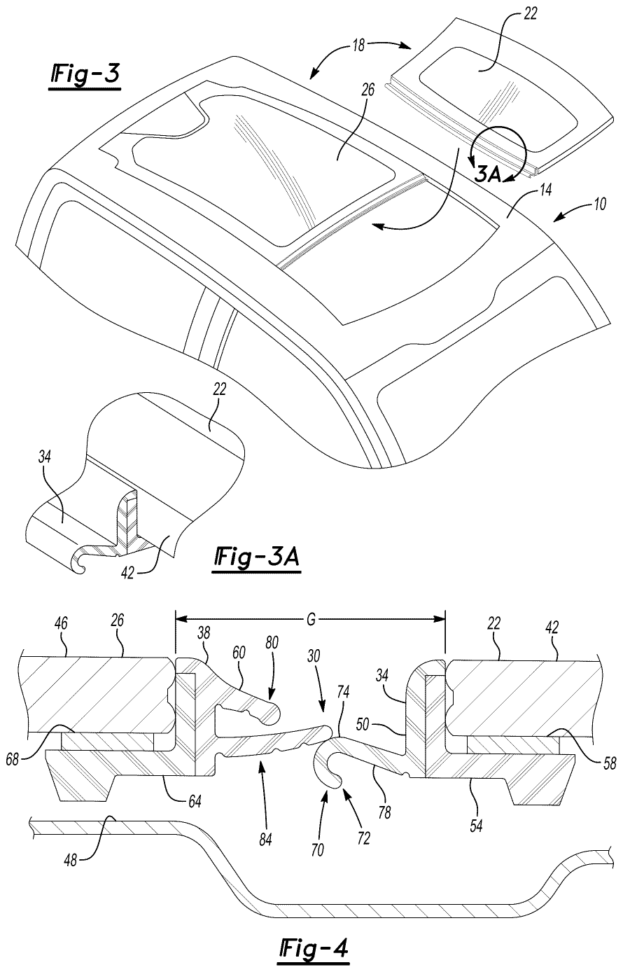

With reference to FIGS. 1-4, a vehicle 10 includes a roof 14 having a window assembly 18 that provides a moonroof. In the exemplary embodiment, the window assembly 18 includes a first window 22 and a second window 26 adjacent to the first window 22. The first window 22 and the second window 26 are adjacent to each other when installed within the roof 14 of the vehicle 10 and can provide a moon roof for the vehicle 10. The first window 22 is a forward window in the exemplary embodiment, and the second window 26 is a rear window. Forward and rear are, for purposes of this disclosure, with reference to an orientation of the vehicle 10.

A gap G is between the first window 22 and the second window 26. The gap G is a distance between first window 22 and the second window 26 when installed. The gap G can vary due to, among other things, manufacturing variability and part variability. The first window 22 and the second window 26 can be laminated windows.

In the exemplary embodiment, a seal assembly 30 is used to seal the gap G. The seal assembly 30 extends longitudinally in a cross-vehicle direction. The seal assembly 30 includes, in the exemplary embodiment, a first seal 34 and a second seal 38. The first seal 34 is secured to a rear edge portion 42 of the first window 22. The second seal 38 is secured to a forward edge portion 46 of the second window 26. Roof sheetmetal 48 can extend along beneath the gap G and the seal assembly 30.

The first seal 34 includes a seal lip 50 and a seal carrier 54. The first seal 34 is secured to the rear edge portion 42 of the first window 22 using a foam, double-sided adhesive tape 58 in this example. In other examples, the first seal 34 could be secured to the rear edge portion 42 in other ways. The seal carrier 54 can be a relatively hard polymer-based material when compared to a material composition of the seal lip 50. In an example, the seal carrier 54 is polypropylene, and the seal lip 50 is santoprene. The seal carrier 54 and the seal lip 50 can be molded together in a two-shot molding process.

The second seal 38 includes a seal lip 60 and a seal carrier 64. The second seal 38 is secured to the forward edge portion 46 of the second window 26 utilizing an adhesive tape 68 in this example. In other examples, the second seal 38 could be secured to the forward edge portion 46 in other ways. The seal carrier 64, like the seal carrier 54, can be molded from a relative hard polymer-based material such as polypropylene, and the seal lip 60 can be santoprene. The seal carrier 64 can be molded together with the seal lip 60, and then secured to the forward edge portion 46 using the adhesive tape 68.

The seal lip 50 includes a hook 70. In this example, the hook 70 is a downturned hook. The hook 70 has a tip 72, a topside 74, and an underside 78. The seal lip 60 of the second seal 38 includes an upper flange 80 and a lower flange 84. The upper flange 80 is shorter than the lower flange 84 in this example. The upper flange 80 is vertically above the lower flange 84 when installed within the vehicle 10. Upper is with reference to ground and a general orientation of the vehicle 10 during operation.

To seal the gap G, the hook 70 of the first seal 34 can interfaces directly with the upper flange 80 or the lower flange 84. How the first seal 34 and the second seal 38 interface with each other can depend on a width of the G and in what order the first window 22 and the second window 26 were installed. In some examples, the upper flange 80, although not directly sealing the gap G, can help to fill the gap and address potential Helmholtz resonance issues.

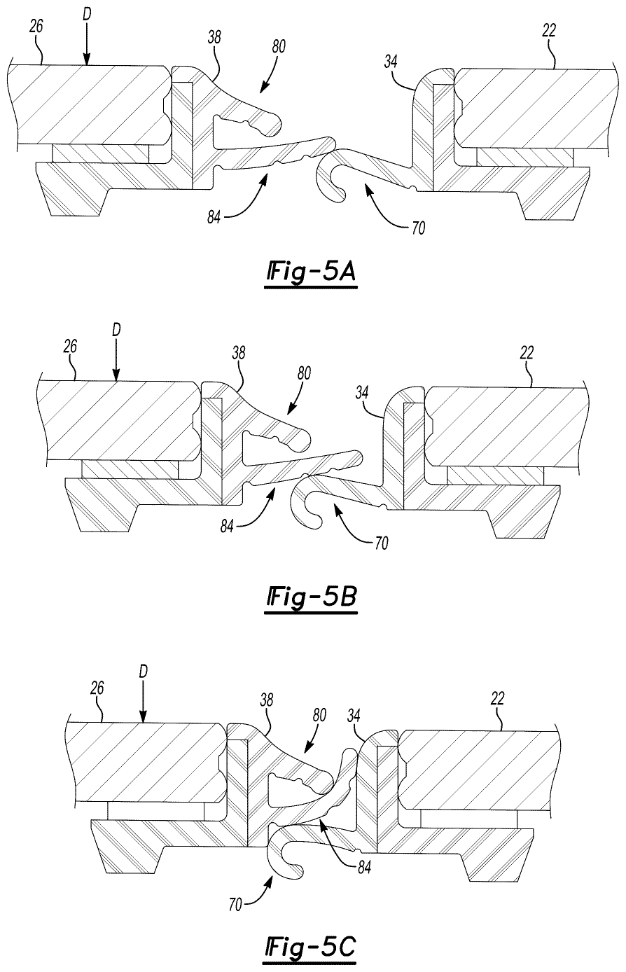

In the examples of FIGS. 5A-5C, the installation sequence of the first window 22 and the second window 26 is the same was what is shown in FIG. 2. That is, the first window 22 with the first seal 34 attached to the rear edge portion 42 is moved to an installed position within the roof 14 of the vehicle 10. After installing the first window 22 and the first seal 34, the second window 26 with the second seal 38 attached to the forward edge portion 46 is moved to an installed position within the roof 14 of the vehicle 10. The second window 26 with the second seal 38 can be moved vertically downward in a direction D from a position above the first window 22, the first seal 34, and the roof 14 to the installed position. As the second window 26 and the second seal 38 are moved downward, the lower flange 84 moves into contact with the topside 74 of the hook 70 to seal the gap G.

In FIG. 5A, the gap G is relatively large. Thus, a distal underside portion of the lower flange 84 is the only portion of the lower flange 84 pressing down in contact with the topside 74 of the hook 70 to seal the gap G.

In FIG. 5B, a distance between the first window 22 and the second window 26 is reduced, and the gap G is a bit smaller than in FIG. 5A. In FIG. 5B, the topside 74 of the hook 70 is in contact with a more central portion of the lower flange 84 to seal the gap G. Further, when installed, the upper flange 80 can contact and press against the lower flange 84 to help hold the lower flange 84 against the topside 74 of the hook 70.

In FIG. 5C, a distance between the first window 22 and the second window 26 is reduced even further, and the gap G is smaller than in FIG. 5B. In FIG. 5C, the lower flange 84 contacts the topside 74 of the hook 70. Other portions of the lower flange 84 contact and press against the portions of the seal lip 50 extending vertically upward from the hook 70. Further, the upper flange 80 can contact the lower flange 84 as shown to press and hold the lower flange 84 in contact with the hook 70 and other portions of the seal lip 50 to seal the gap G.

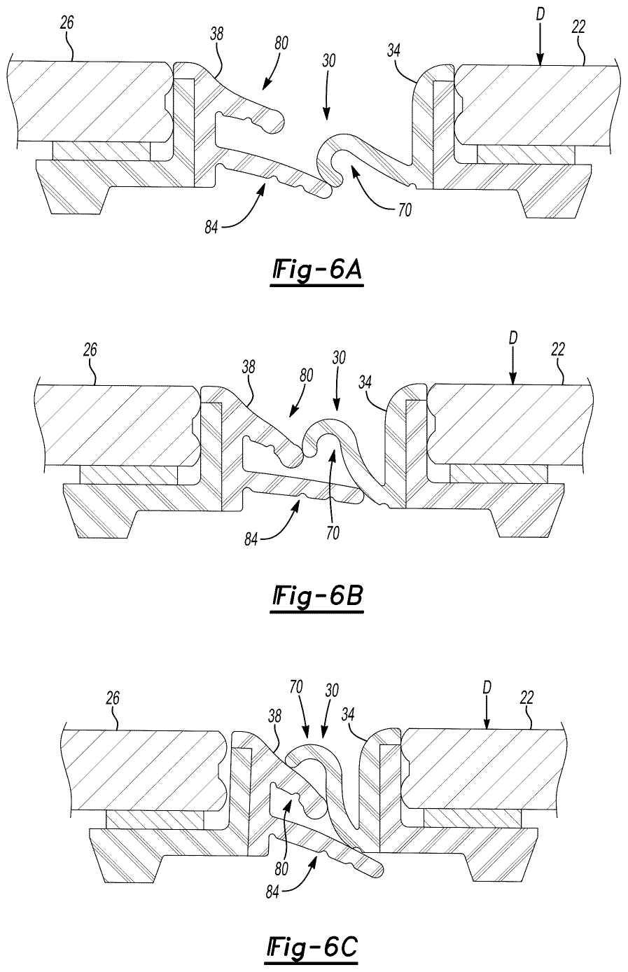

With reference now to FIGS. 6A-6C, the installation sequence of the first window 22 and the second window 26 is the same was what is shown in FIG. 3. That is, the second window 26 with the second seal 38 attached to the forward edge portion 46 is moved to an installed position within the roof 14 of the vehicle 10. After installing the second window 26 and the second seal 38, the first window 22 with the first seal 34 attached to the rear edge portion 42 is moved to an installed position within the roof 14 of the vehicle 10. The first window 22 with the first seal 34 can be moved vertically downward in a direction D from a position above the second window 26, the second seal 38, and the roof 14 to the installed position. As the first window 22 and the first seal 34 are moved downward, the hook 70 moves into contact with, depending on a size of the gap G, the upper flange 80 and/or the lower flange 84 to seal the gap G.

As shown in FIG. 6A, the gap G between the first window 22, and the second window 26 is relatively large. After moving the first window 22 and the first seal 34 downward to the installed position of FIG. 6A, the tip 72 of the hook 70 contacts the lower flange 84 to seal the gap G.

With reference now to FIG. 6B, the gap G is a bit smaller than the gap G shown in FIG. 6A. In FIG. 6B, as the first window 22 and the first seal 34 are moved to the installed position, the tip 72 of the hook 70 contacts the upper flange 80 to seal the gap G. Further, the underside 78 of the hook 70 contacts the lower flange 84 to further seal the gap G.

With reference now to FIG. 6C, the gap G is smaller than the gap G shown in FIG. 6B. In FIG. 6C, as the first window 22 and the first seal 34 are moved to the installed position, the underside 78 of the hook 70 contacts both the lower flange 84 and the upper flange 80 to seal the gap G. The tip 72 also contacts the upper flange 80 to further seal the gap.

While the window assembly 18 is described in connection with providing a moonroof for the vehicle 10, the seal assembly 30 and other exemplary embodiments of this invention could be utilized to seal gaps between window assemblies located in other areas of the vehicle. That is, the teachings of this disclosure are not limited to sealing gaps between roof windows of vehicles.

Features of the disclosed embodiments include a seal assembly that seals a gap between first and second windows when the first window is installed prior to the second window, and when the second window is installed prior to the first window. The seal assembly thus provides a sealed gap regardless a sequence in which the windows are assembled. Further, the seal assembly does not extend vertically out of the gap to protrude past the first window or the second window, which could potentially lead to noise issues in some examples.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle window assembly, comprising:
a first window;
a second window adjacent to the first window;
a first seal attached to the first window, the first seal having a hook; and
a second seal attached to the second window, the second seal having at least one flange;
the hook of first seal and the at least one flange of the second seal interfacing with each other to seal a gap between the first window and the second window.

2. The vehicle window assembly of claim 1, wherein the first window and the second window are roof windows of a vehicle.

3. The vehicle window assembly of claim 1, wherein the first window is a forward window, and the second window is a rear window.

4. The vehicle window assembly of claim 1, wherein the first window is a rear window, and the second window is a forward window.

5. The vehicle window assembly of claim 1, wherein the gap extends longitudinally in a cross-vehicle direction.

6. The vehicle window assembly of claim 1, wherein the first seal is attached to a rear edge portion of the first window, and the second seal is attached to a forward edge portion of the second window.

7. The vehicle window assembly of claim 1, wherein the hook is a downturned hook.

8. The vehicle window assembly of claim 1, wherein the at least one flange includes an upper flange and a lower flange.

9. The vehicle window assembly of claim 8, wherein the upper flange is shorter than the lower flange.

10. The vehicle window assembly of claim 1, wherein the at least one flange is configured to seal against an topside of the hook when the first window is installed prior to the second window, and configured to seal against an underside of the hook when the first window is installed after the second window.

11. The vehicle window assembly of claim 10, wherein the at least one flange includes an upper flange and a lower flange.

12. The vehicle window assembly of claim 11, wherein the upper flange is shorter than the lower flange.

13. The vehicle window assembly of claim 12, wherein, when the first window is installed prior to the second window, the upper flange is configured to press the lower flange against the topside of the hook and when the gap is below a threshold distance.

14. The vehicle window assembly of claim 11, wherein, when the first window is installed prior to the second window, the underside of the hook is configured to seal against the upper flange when the gap is below a threshold distance and configured to seal against the lower flange when the gap is at or above the threshold distance.

15. A vehicle window installation method, comprising:
attaching a first seal to a first window, the first seal having a hook;
attaching a second seal to a second window, the second seal having at least one flange; and
installing the first window and the second window in a vehicle such that the first window and the second window are adjacent to each other and a gap between the first window and the second window is sealed by contact between the first seal and the second seal,
when the first window is installed in the vehicle before the second window, a topside of the hook contacts the at least one flange to seal the gap,
when the first window is installed in the vehicle after the second window, an underside of the hook contacts the at least one flange to seal the gap.

16. The vehicle window installation method of claim 15, wherein the first window is a front roof window, and the second window is a rear roof window.

17. The vehicle window installation method of claim 15, wherein the at least one flange includes an upper flange and a lower flange, wherein, when the first window is installed in the vehicle before the second window, the upper flange is configured to contact the lower flange to press the lower flange against the topside of the hook when the gap is below a threshold distance.

18. The vehicle window installation method of claim 15, wherein the at least one flange includes an upper flange and a lower flange, wherein, when the first window is installed in the vehicle after the second window, the underside of the hook contacts the upper flange to seal the gap when the gap is below a threshold distance and contacts the lower flange to seal the gap when the gap is at or above the threshold distance.

19. The vehicle window installation method of claim 18, wherein the upper flange is shorter than the lower flange.
